(19) United States
(12) Patent Application Publication
(10) Pub. No.: US 2026/0250161 A1
(43) Pub. Date: Aug. 27, 2026

(54) Method for Increasing Reverse Osmosis Recovery for High Silica Waters

(71) Applicants: Sebastien BESSENET, Naperville, IL (US); Jphn KORPIEL, Wexford, PA (US); Veolia Water Solutions & Technologies Support, Saint-Maurice (FR)

(72) Inventors: Sebastien Bessenet, Meyssac (FR); John A. Korpiel, Wexford, PA (US)

(21) Appl. No.: 18/861,645

(22) PCT Filed: May 1, 2023
(86) PCT No.: PCT/US2023/020520

§ 371 Date: Oct. 30, 2024

Related U.S. Application Data
(60) Provisional application No. 63/338,230, filed on May 4, 2022.

(51) Int. Cl. C02F 1/44; C02F 1/28; C02F 101/10

(52) U.S. Cl. CPC C02F 1/441; C02F 1/28; C02F 2101/10

(57) ABSTRACT

The present invention is a semi-batch, multi-phase reverse osmosis process for treating water containing silica which aims to achieve recovery rates of 90% and higher without requiring chemical intensive pretreatment.

### FIELD OF THE INVENTION

The present invention relates to reverse osmosis processes for treating water, and more particularly to reverse osmosis processes for treating water having high concentrations of silica.

### BACKGROUND OF THE INVENTION

Conventional reverse osmosis (RO) systems are used to treat water having relatively high silica concentrations. Recovery rates typically achieved by conventional RO system treating water with significant concentration of silica are limited. Recovery rates can be increased by employing processes that remove silica through pretreatment. For example, it is known to employ chemical precipitation to remove silica prior to treatment in an RO system.

Another pretreatment approach entails chemical addition to the water designed to raise the pH of the water, which in turn increases the solubility of silica, which tends to reduce the tendency of the RO membranes to scale. Furthermore, it is common practice to inject an antiscalant into the RO feedwater, and particularly a silica specific antiscalant, to achieve 150%-250% silica saturation in the RO concentrate. There are drawbacks to these chemical addition and pretreatment processes. These and other pretreatment processes are costly to implement and maintain, especially since they require chemical addition. Moreover, with chemical precipitation, for example, comes the production of sludge and the requirement to incorporate solids-liquid separation processes to remove the sludge and the further requirement of appropriately disposing of the sludge. Antiscalants are limited in their ability to inhibit silica scale formation. Also, when using a silica-specific antiscalant, other scalants and foulants (e.g., calcium carbonate, magnesium, iron, and aluminum) need to be carefully controlled via robust pretreatment and/or chemical conditioning, because their presence in excessive concentrations can inhibit the silica-specific antiscalant's effectiveness. The method or process described below achieves much higher silica concentrations in the RO concentrate than what is achievable using conventional RO with an antiscalant and without resorting to robust and chemical intensive pretreatment (e.g., chemical softening or chemical precipitation).

Thus, the problem is to develop an RO system and process that achieves relatively high recovery rates when treating water having high concentrations of silica without requiring chemical precipitation or other processes that require chemical intensive pretreatment.

### SUMMARY OF THE INVENTION

The present invention, in one embodiment, is a semi-batch multi-phase reverse osmosis (RO) process for treating water containing silica which aims to achieve recovery rates of 90% and higher without necessarily requiring the addition of chemicals.

In one embodiment, the present invention entails a multi-phase reverse osmosis process including a reverse osmosis unit that produces a permeate and a concentrate. The concentrate which includes silica is mixed with the water containing silica to form an RO feed that is continuously directed to and through the RO unit. During this first phase, the silica concentration of the feed will increase. Once the silica concentration of the feed reaches a selected level or setpoint, for example near or at saturation, the process is switched from the first phase to a second phase. In the second phase, the feed of concentrate and water, or a portion thereof, is directed through a silica adsorption unit located upstream of the RO unit. As the feed flows through the silica adsorption unit, silica is adsorbed on media in the silica adsorption unit. During the second phase, the silica concentration in the feed is maintained generally constant at near saturation, but preferably just below saturation. The second phase is continued until a second setpoint or threshold is realized. In one embodiment, the second setpoint is based on the process reaching a selected recovery rate such as, for example, a recovery rate of 90% or higher. Once the second setpoint or threshold is reached, the process is switched from the second phase to a third purge phase. In this third purge phase, the concentrate emitted by the RO unit is purged from the process.

Also described is a second embodiment where the water to be treated is super saturated, saturated, or nearly saturated with silica. Here, the first production phase entails directing the RO feed, or a portion thereof, through the silica adsorption unit, which reduces the silica concentration of the RO feed prior to reaching the RO unit. In the second phase, all or a substantial portion of the RO feed bypasses the silica adsorption unit, and the silica concentration of the concentrate is increased to supersaturation. Thereafter, the process is shifted to a third purge phase, where the concentrate is purged from the RO system.

Other objects and advantages of the present invention will become apparent and obvious from a study of the following description and the accompanying drawings which are merely illustrative of the invention.

### DESCRIPTION OF THE DRAWINGS

FIG. 1 is a schematic illustration depicting a first production phase of the multi-phase reverse osmosis process of the present invention.

FIG. 2 is a schematic illustration depicting a second production phase of the multi-phase reverse osmosis process of the present invention.

FIG. 3 is a schematic illustration depicting a third purge phase of the multi-phase reverse osmosis process of the present invention.

FIG. 4 is an exemplary graph illustrating how the recovery rate of the multi-phase RO process varies over several phases.

FIG. 5 is a schematic illustration of a first production phase of a second process designed to treat water saturated, supersaturated or nearly saturated with silica.

FIG. 6 is a schematic illustration of a second production phase of the process.

FIG. 7 is a schematic illustration of a third concentrate purge phase of the process.

FIG. 8 is an exemplary graph illustrating how the recovery rate of a second multi-phase RO process varies over several phases.

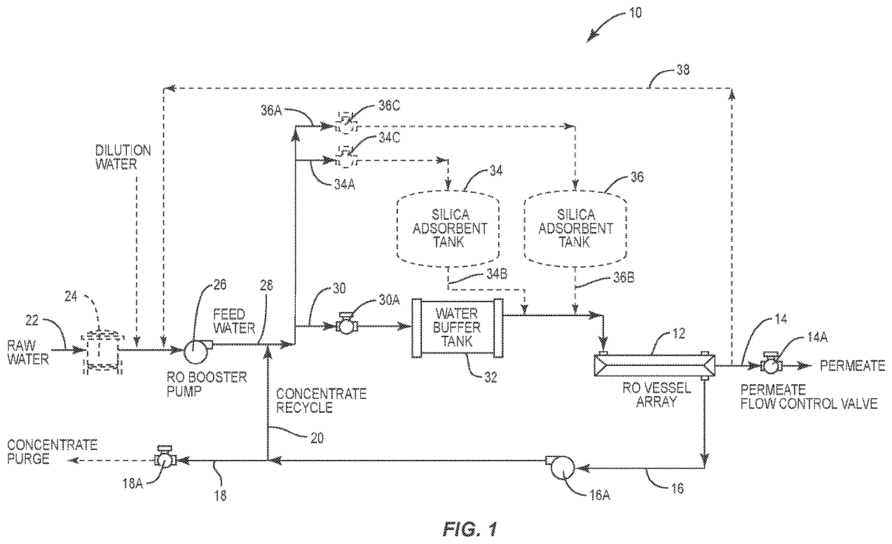

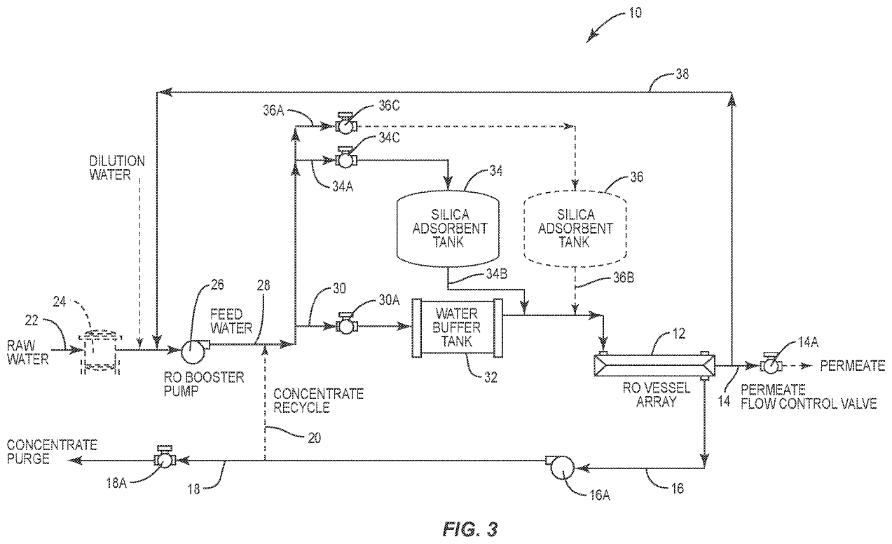

FIGS. 1-3 and 5-7 schematically illustrate the three phases of the two different RO process described hereafter. The schematic illustrations include full lines and dotted lines. In each figure, the full lines represent the active portions of the process while the dotted lines represent inactive portions of the process.

### DESCRIPTION OF EXEMPLARY EMBODIMENTS

With further reference to the drawings, there is shown therein a reverse osmosis (RO) system, indicated generally by the numeral 10, designed to carry out the semi-batch multi-phase RO process described hereafter. A multi-phase reverse osmosis process is different from a conventional steady state reverse osmosis process in that the process includes several distinctive phases. Before addressing the RO process, it is beneficial to briefly review the components of the RO system 10. With reference to FIGS. 1-8, the RO system 10 includes a RO vessel array 12 that is sometimes referred to as an RO unit. RO unit 12 produces a permeate and a concentrate. Extending from the RO unit 12 is a permeate line 14 that includes an automated permeate control valve 14A, which can be either an automatic modulating control valve or an automatic on/off valve. In certain phases in the RO process, it is beneficial to recycle permeate or a portion of the permeate. This is particularly true during the purge phase of the process. To accommodate the permeate recycle, there is provided a permeate recycle line 38 which may include an automated valve or an orifice plate. In many cases, an orifice plate is preferable because it can be designed to prevent permeate recycle during a production phase but yet permit permeate recycle during a purge phase. Also extending from the RO unit 12 is a concentrate line 16 that includes pump 16A. Concentrate line 16 is operatively connected to a purge line 18 that includes a purge control valve 18A. Concentrate purge valve 18A is preferably a modulating flow control valve that can be partially opened to maintain a concentrate flow rate setpoint. Furthermore, concentrate line 16 is operatively connected to a concentrate recycle line 20. A raw water inlet line 22 directs the water to be treated into the RO system 10. Optionally included in the raw water inlet line 22 is a filter unit 24. Filter unit 24 is not necessary in many applications of the present invention. An RO booster pump 26 is provided in the raw water inlet line 22 and, as will be appreciated from later discussion, is operative to drive the RO feed (a mixture of concentrate and raw water) through the RO unit 12 and various components that lie between the booster pump and the RO unit. Downstream of the RO booster pump 26 is a feed line 28. Concentrate recycle line 20 joins the feed line 28 downstream of the booster pump 26.

Feed line 28 is operatively connected to a through line 30 that includes a modulating flow control valve 30A and a buffer tank 32. Disposed in parallel relationship with the buffer tank 32 are two (or more) silica adsorption units 34 and 36 which are themselves disposed in parallel relationship. Feed lines 34A and 36A are operative during certain phases of the process to direct RO feed to either of the silica adsorption tanks 34, 36. Each silica adsorption unit 34, 36 includes media that is effective in adsorbing dissolved silica in the feed as the feed passes through the silica adsorption units and contacts the media therein. Various types of media are known to adsorb silica. For example, dissolved silica in an ionic form can be removed from solution using a metal oxide adsorbent such as activated alumina, goethite, or hematite.

Continuing to refer to FIGS. 1-3, feed lines 34A and 36A are operative to convey the feed from feed line 28 to the respective silica adsorption units 34 and 36. Note also effluent lines 34B and 36B that extends from the silica adsorption units. In order to control the flow of feed through the silica adsorption units 34 and 36 during certain phases of the RO process, the feed lines 34A and 36A include automated valves 34C and 36C, which can be either automatic modulating control valves or automatic on/off valves. In the exemplary process shown and described, it is envisioned that during the multi-phase process, that only one silica adsorption unit will be online at any one time, while the other silica adsorption unit will be undergoing regeneration or after regeneration would assume a standby ready mode.

The process shown in FIGS. 1-3 and described below can be used to treat water containing silica where the silica concentration varies over a substantial range. However, the process is particularly suitable for treating water having moderate concentrations of dissolved silica, i.e. silica concentrations less than saturated. Typically, silica concentrations of the water to be treated is in the approximate range of 20-45 mg/L but could be higher. In the first production phase of the process, concentrate produced by the RO unit 12 is recycled and mixed with the raw water to form the feed and the feed is directed through line 30 and through the water buffer tank 32 into the RO unit 12 which produces the permeate directed out line 14, as well as the previously mentioned concentrate. In the first phase, valves 30A and 14A are open. All other valves are closed. So in the first phase, the entire RO feed bypasses the silica adsorbent units 34 or 36. In the first phase, as the number of turns increase, so does the concentration of silica in the feed. The term “turns” is used in semi-batch RO systems, such as the present invention, which do not operate in a continuous steady state mode. A turn is one trip of the recirculating concentrate through the RO unit 12. The process is designed to continue in the first phase until the concentration of silica in the concentrate reaches a selected level. One of the principles of the process is that the first phase is operated until the number of turns results in a silica concentration in the concentrate that enables the silica adsorption unit 34 or 36 to operate at optimum or near optimum efficiency. Generally, this occurs when the silica in the concentrate becomes saturated or nearly saturated. Depending on temperature, pH, water chemistry and other variables, this can occur, in one example, when the silica concentration in the concentrate reaches approximately 100 mg/L.

As those skilled in the art appreciate, measuring silica concentration online is difficult. However, as also appreciated by those skilled in the art, there are a number of indirect approaches to determining or estimating dissolved silica concentration in the concentrate. For example, a triggering setpoint can be based on the conductivity of the concentrate as there is a relationship between silica concentration and conductivity. Conductivity of the concentrate can be measured and monitored continuously via an online conductivity instrument operatively connected to a programmable logic controller (PLC). Also, RO system recovery rate may be used as a setpoint basis. Generally there is a relationship or correlation between system recovery rate and the silica concentration of the concentrate. By monitoring and measuring various flow rates in the RO system, recovery rate can be determined via a PLC. Moreover, setpoints in the present process can be based on timer settings. Throughout the processes described here, one approach for triggering a phase change is to base the phase change on all three approaches-concentrate conductivity, RO system recovery rate, timer settings- and initiate the phase change when the first event or first setpoint occurs.

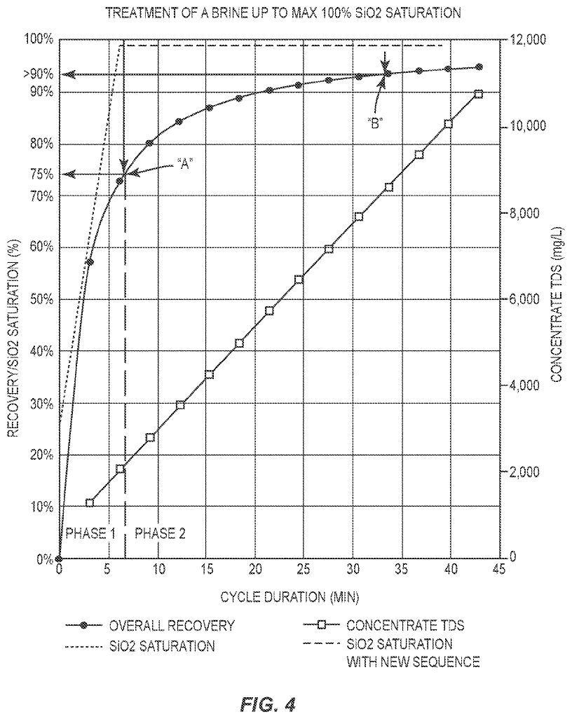

One concept underlying the process shown in FIGS. 1-3 is to operate the process in the first phase up to a point where the silica concentration of the concentrate starts to approach saturation. Once the silica concentration in the feed approaches saturation or a reasonable degree of supersaturation allowed by the addition of antiscalants, it is no longer advisable or prudent to operate the process in the first phase because of the risk associated with RO membrane fouling. At this point in the process, it is anticipated that the recovery rate would be approximately 75% or in the range of 60-75%. See letter “A” on FIG. 4. However, the aim of the multi-purpose process is to achieve a substantially higher recovery rate, a recovery rate on the order of 90% or above. See letter “B” on FIG. 4. It is at this point in the process where the process is switched from the first production phase to the second production phase. As discussed below, in the second phase, one silica adsorption unit 34 or 36 is brought online and functions to remove silica from the RO feed while permeate production continues. Further, once the silica adsorption unit 34 or 36 is brought online, the process is controlled throughout the second phase such that the silica concentration of the concentrate is maintained generally constant and near saturation, preferably just below saturation.

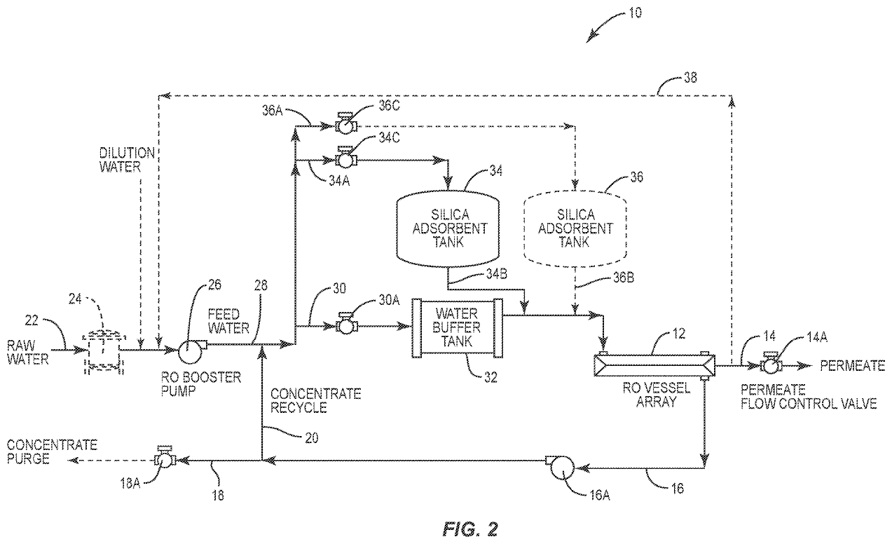

In one example, the entire RO feed is routed through one of the silica adsorption units 34 or 36. Valves 34C and 14A are open and all remaining valves are closed. See FIG. 2. In another example, only a portion of the RO feed is routed through one of the silica adsorption units while another portion of the feed is directed through line 30 into and through the water buffer tank 32. In this case, valves 30A, 34C and 14A are open while the remaining valves are closed. In either case, the adsorbent media in the silica adsorbent unit is not fully loaded or exhausted and at the beginning of the second phase, it follows that the silica adsorption unit is efficient in removing silica from the RO feed. The effectiveness of the adsorbent media is not necessarily linked to the duration of the second phase or even to the three phases of the process. It is anticipated that the effectiveness of the adsorbent media, before requiring regeneration, could span over multiple cycles of the multi-phase process, (a cycle being a complete cycle of the first, second and third phases of the process), potentially several days.

This may be significant in as much as regenerating the adsorbent media in the silica adsorption unit 34 or 36 may last significantly longer than the time needed to go through one cycle of the multi-phase process.

As noted above, in the second phase the process is controlled such that the silica concentration of the concentrate remains generally constant and parameters of the process are set to insure that the silica concentration is controlled such that the RO membranes can operate efficiently and withstand the silica concentration in the concentrate. This can mean that the feed directed through the silica adsorbent unit and the feed directed through the buffer tank 32 is monitored and balanced to control the silica concentration of the concentrate leaving the RO unit 12 at just below saturation. In cases where it is desirable to split the feed to the RO unit 12 between one silica adsorbent unit 34 or 36 and the through line 30 (including the buffer tank 32), it is appreciated that the silica adsorbent unit will induce a head loss. To counter this and to account for it, some means in the form of an adjustable valve or some mechanical resistance can be incorporated so that the flow rate of feed through line 30 and the silica adsorbent unit 34 or 36 can be controlled. For example, valve 30A in line 30 can be a modulating flow control valve that is controlled so as to prevent the feed from taking the path of least resistance which in this case would be through the water buffer tank 32. Thus, control valve 30A is controlled so that the flow rate of the RO feed through the silica adsorbent tank 34 or 36 is not starved.

Preferably, adequate flow monitoring instrumentation is implemented to ensure the desired flow through the various units are being maintained. In this case, the flow rate instrumentation will automatically control, via a programmable logic controller, the positioning of the flow control valve 30A such that the valve is completely open, completely closed or partially open.

During the second phase, the recovery rate of the RO process continues to increase relative to the recovery rate achieved in the first phase. See FIG. 4. Eventually, however, the process will reach a maximum recovery rate greater than 75% and in many cases, approximately 90% and even higher. See point “B” shown in FIG. 4. When this occurs, the process is switched from the second production phase to a third purge phase. The triggering setpoint event can be the same as discussed above with respect to the shift from the first production phase to the second production phase. Thus, a setpoint based on system recovery rate, concentrate conductivity, timer setting, and high feed pressure can be used here with the provision that the actual triggering event take place when the first event or setpoint is reached. In the third purge phase, one of the silica adsorbent units 34 or 36 can be online or offline. If offline, valves 18A and 30A are open while valves 14A, 34C and 36C are closed. If online, valve 34C or 36C is open. Whether one of the silica adsorbent units 34 of 36 is online or offline depends on the incoming raw water silica concentration. That is, the chemistry of the raw water will dictate how much of the feed is directed through the silica adsorbent unit 34 of 36 and how much of the RO feed will be directed through line 30 and the buffer tank 32. Again, this can be controlled by modulating control valve 30A in line 30. During the third purge phase, various purge sources or combination of sources can be used to purge the concentrate from the RO system. These purge sources include influent water (the raw water influent), permeate recycle through line 38, or the addition of dilution water. At some point, the third purge phase is completed. The completion of the third purge phase can be based on purge volume, the conductivity of the concentrate, or a timer setting as a group where the triggering event takes place when the first event or the first setpoint is met.

FIG. 4 is a graphical depiction of a number of process variables and how they might vary over the first and second phases of the process described above. It shows the recovery rate of the process through the first and second phases, the silica saturation in percentages across the first two phases, as well as the concentration of total dissolved solids in the concentrate over the two phases and at the same time these variables are plotted against cycle duration. During the first phase, the silica saturation reaches almost 100% while the achieved recovery rate is 75%. However, once the process enters the second phase, the recovery rate increases to approximately 90% and at the same time, the silica saturation remains close to 100%.

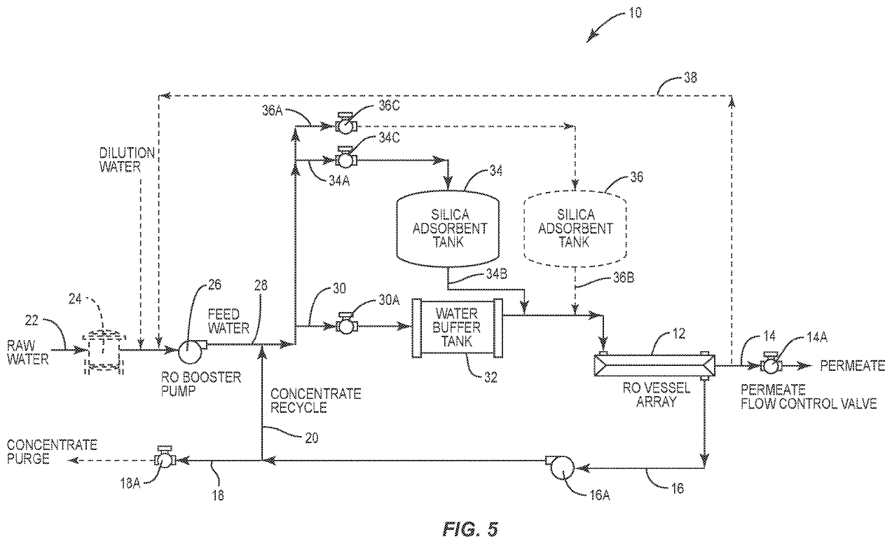

The multi-phase RO process shown in FIGS. 1-3 and discussed above is particularly suitable for applications where the silica concentration of the raw water is less than saturation. There are, however, applications where the silica concentration of the raw water or influent is supersaturated, saturated or nearly saturated. The term “nearly saturated” as used herein means that the silica concentration is less than 100% saturation but greater than 75% saturation. For example, the process shown in FIGS. 5-7 and described below could be used to treat the concentrate from another RO system in which case the RO concentrate to be treated is supersaturated, saturated or nearly saturated with silica.

FIG. 5 schematically shows a first production phase of an RO process for treating an influent that is supersaturated, saturated or nearly saturated with silica. In this case, the silica adsorbent tank 34 is online. Hence, valves 34C and 14A are open. Valves 36C and 18A are closed. Because of the high silica concentration in the influent, it is contemplated that during this first production phase, all of the RO feed or at least a majority of the RO feed will be directed through the silica adsorbent unit 34. In cases where all of the RO feed is directed through the silica adsorbent unit 34, then modulating control valve 30A is closed. In this first production phase, the process is controlled such that the global silica concentration is maintained generally constant in the RO system and at a silica concentration level that enables the silica adsorbent unit 34 to operate at optimum efficiency. Thus, so long as the silica adsorbent unit 34 is operating at optimum efficiency, a substantial portion of the RO feed is directed through the silica adsorbent unit so as to reduce the silica concentration of the RO feed before it reaches the RO unit 12. However, due to the particular chemistry of the influent, it may be advisable to direct some of the RO feed through line 30 and directly into the RO unit 12. It is this case where the RO feed may be split into a first RO feed stream that is directed through the silica adsorbent unit 34 and a second RO feed stream that is directed through the buffer tank 32. In this case, the modulating valve 30A is open and controlled so as to balance the flow of RO feed through the buffer tank 32 and the silica adsorbent unit 34 such that the silica adsorbent unit 34 is operating generally in an optimum efficiency range. Throughout the first production phase, the modulating valve 30A is controlled to maintain this balanced approach of controlling the global silica concentration generally constant while maintaining the efficiency of the silica adsorbent unit 34 within an optimal range.

In some cases, the setpoint for concluding the first production phase can be based on the determined recovery rate of the RO system. Also in some cases, the first setpoint can be based on the concentrate conductivity measurement or a timer setting. As discussed before, all three of these possibilities can be grouped and the phase shift is triggered at the first occurrence of any one of the three. In this first production phase, one can anticipate a system recovery rate of 50-75%. To achieve a higher recovery rate on the order of 90-95%, the process is switched from the first production phase to a second production phase.

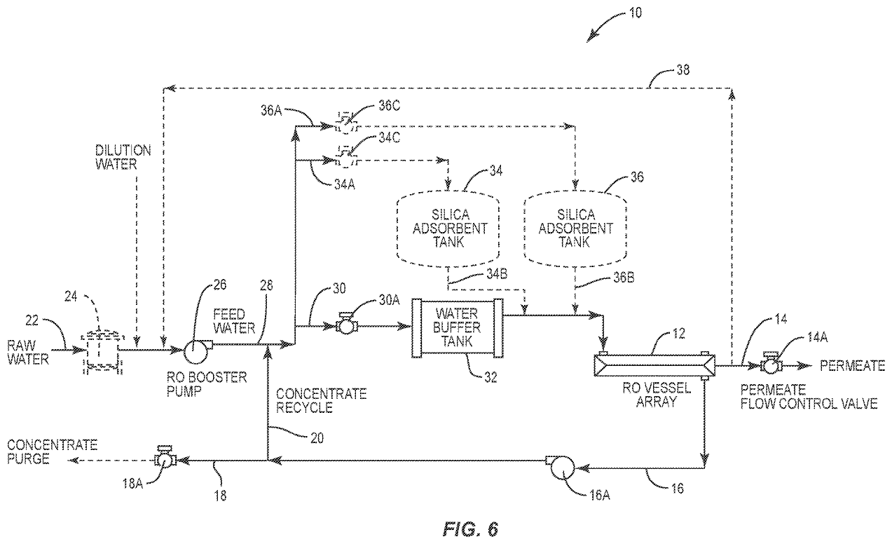

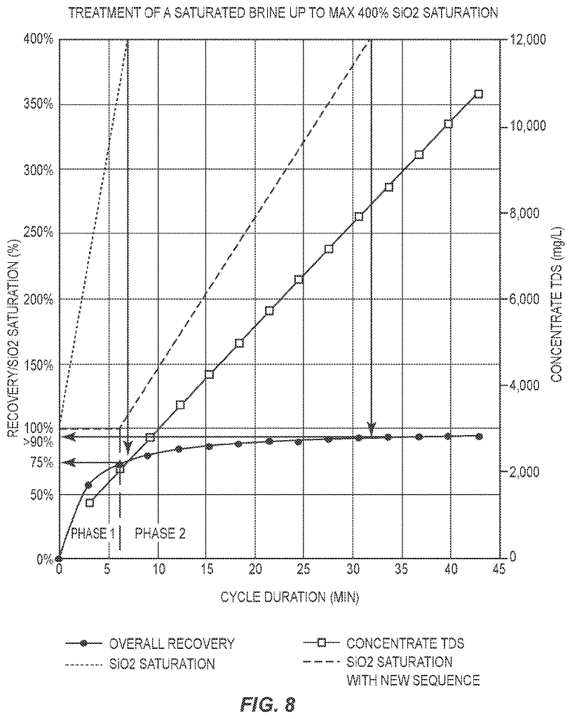

FIG. 6 schematically shows the second production phase. Here, the silica adsorbent unit 34 is offline. Hence, valves 34C and 18A are closed while the modulating valve 30A and the permeate flow control valve 14A are open. As depicted in FIG. 8, during the second production phase, the concentration of silica in the concentrate increases over time, and so does the system recovery rate. See FIG. 8. A second setpoint or threshold is employed for the purpose of terminating the second production phase. The second setpoint can be based on the silica concentration or conductivity of the concentrate, the system recovery rate, high feed pressure, or a timer setting or a combination of any one of these. Generally, the process is designed such that a 90% or higher recovery rate is achieved and when that occurs, it is anticipated that the silica concentration of the concentrate can be as high as 400% saturation for example, or potentially higher. See FIG. 8. Once this setpoint is reached, the process switches from the second production phase to a third concentrate purge phase.

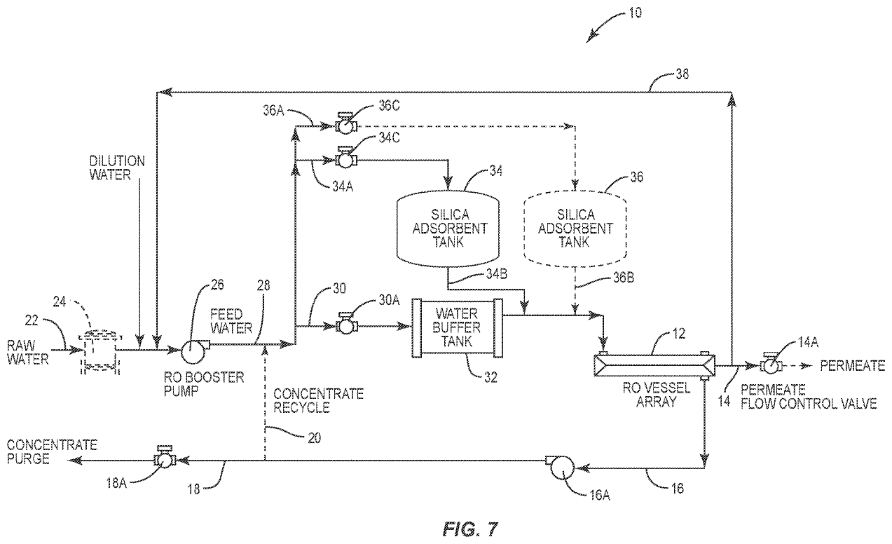

FIG. 7 schematically shows the third phase of the process, the concentrate purge phase. In this phase, the silica adsorbent unit 34 can be online or offline. If offline, the modulating flow control valve 30A is open such that the purge flows through the valve and through the water buffer tank 32 to the RO unit 12. If online, modulating control valve 30A can be closed or modulated to appropriately control the ratio of purge through the silica adsorbent tank 34 and the water buffer tank 32. In all cases during the third phase, valve 14A is closed and valve 18A is open.

At the beginning of the concentrate purge phase, the concentrate in the system is highly concentrated with silica (as high as 400% saturation). To purge the concentrate, various purge sources can be employed. First, the permeate produced by the RO unit 12 can be recycled via line 38 to the front of the process where the permeate functions to purge the concentrate in the system. In addition, dilution water can be fed into the system at a point just upstream of the RO booster pump 26. See FIG. 7. Finally, feedwater from other sources can be directed into line 22 for the purpose of purging or assisting in the purging of concentrate. For example, potential dilution water could be the feedwater or pretreated feedwater from a primary RO system from which the present process is treating the concentrate. One or more of these sources can be used. There are advantages in using permeate or dilution water to purge the concentrate from the system. This results in reducing the silica concentration in the concentrate below saturation. After 2-3 turns, this yields a flushing and cleaning effect to the RO system so that the induction time can be leveraged in the succeeding turns. Whether the silica adsorbent unit 34 is online or offline depends on the silica concentration of the incoming feedwater. That is, the feedwater chemistry will dictate the ratio of feedwater directed through the silica adsorbent unit 34 to the feedwater that is directed through the water buffer tank 32. One advantage of the process shown in FIGS. 5-7 is that it enables RO recovery rates on the order of 90% and higher even where the silica concentration of the concentrate in phases two and three approaches 400% saturation. See FIG. 8. Note in the first phase where the silica concentration of the concentrate is maintained about 100% saturation. This can typically yield a 75% recovery rate. But after shifting from the first phase to the second production phase (FIG. 6), over time the silica concentration in the concentrate increases and can approach 400% saturation. At the same time, the system recovery rate increases from 75% to 90%. See FIG. 8. With conventional RO processes, recovery rates exceeding 75% cannot be expected when the RO concentrate is supersaturated or saturated in silica as is the case in the second and third phases of the process described above. One obvious concern in RO systems and processes is the risk of the RO membranes fouling. The process described mitigates against RO membrane fouling. This is because a purge (whether RO permeate, dilution water, or other feedwater) is unsaturated in silica concentration and that enables the process to disrupt the chemistry that tends to lead to fouling and utilizes the silica induction time advantage. That is, it takes a certain time for supersaturated silica to precipitate and foul the RO membranes, and if the silica concentration is diluted to an unsaturated concentration prior to the induction time, silica will not foul the RO membranes.

The present invention may, of course, be carried out in other specific ways than those herein set forth without departing from the scope and the essential characteristics of the invention. The present embodiments disclosed herein are therefore to be construed in all respects as illustrative and not restrictive and all changes coming within the meaning and equivalency range of the appended claims are intended to be embraced therein.

1-20. (canceled)

21. A multi-phase process for treating water containing silica in a reverse osmosis (RO) system including a silica adsorption unit and an RO unit that produces a permeate and a concentrate, the process comprising:
in a first production phase:
mixing the concentrate from the RO unit with the water to be treated to form an RO feed and directing the RO feed through the RO unit to produce the permeate;
continuing to direct the RO feed through the RO unit until a silica concentration in the concentrate reaches a setpoint, at which time the process is switched from the first production phase to a second production phase;
in the second production phase:
reducing the concentration of the silica in the concentrate by mixing the concentrate from the RO unit with the water to be treated to form the RO feed and directing at least a portion of the RO feed through the silica adsorption unit containing a media that adsorbs silica from the RO feed as the RO feed passes through the silica adsorption unit;
after passing the RO feed through the silica adsorption unit, directing the RO feed, depleted in silica, through the RO unit and continuing to produce the permeate;
continuing the second production phase of the process until a production threshold setpoint is reached, at which time the process is switched from the second production phase to a third concentrate purge phase; and
in the third concentrate purge phase:
purging the concentrate from the RO system.

22. The process of claim 21 wherein during the second production phase a portion of the RO feed bypasses the silica adsorption unit and combines with the portion of the RO feed exiting the silica adsorption unit upstream of the RO unit.

23. The process of claim 21 wherein during the second production phase, the silica concentration of the concentrate is maintained generally constant and near but below saturation so as to give rise to an efficient silica adsorption process in the silica adsorption unit.

24. The process of claim 21 wherein during the third purge phase, at least a portion of the water to be treated is directed through the silica adsorption unit prior to reaching the RO unit.

25. The process of claim 21 wherein during the second production phase, the RO feed is split into first and second portions with the first portion of the RO feed directed through the silica adsorption unit and the second portion of the RO feed directed through a bypass line that bypasses the silica adsorption unit; and wherein the first and second portions of the RO feed are combined upstream of the RO unit.

26. A multi-phase process for treating water supersaturated, saturated or nearly saturated with silica in an RO system including a silica adsorption unit and an RO unit that produces a permeate and a concentrate, the process comprising:
in a first production phase:
mixing the concentrate from the RO unit with said water supersaturated, saturated or nearly saturated with silica to form an RO feed;
reducing the concentration of silica in the RO feed prior to reaching the RO unit by directing at least a portion of the RO feed through the silica adsorption unit located upstream from the RO unit that contains a media that adsorbs silica from the RO feed as the RO feed passes through the silica adsorption unit;
continuing the first production phase until a first setpoint is reached;
once the first setpoint is reached, switching the process from said first production phase to a second production phase;
in the second production phase: bypassing the silica adsorption unit with a substantial portion of the RO feed and directing the substantial portion of the RO feed through the RO unit to produce the permeate and the concentrate;
continuing to direct the substantial portion of the RO feed through the RO unit and causing the concentrate produced by the RO unit to become supersaturated with silica;
upon reaching a second setpoint, switching the process from the second production phase to a concentrate purge phase;
in the concentrate purge phase:
purging the supersaturated concentrate from the RO system.

27. The process of claim 26 wherein the concentrate purge phase includes purging the supersaturated concentrate from the RO system by directing the water to be treated, dilution water or permeate recycle or a combination thereof through the RO system.

28. The process of claim 26 wherein in the first production phase, the silica concentration of the concentrate is maintained near saturation.

29. The process of claim 26 wherein the silica concentration of the concentrate in the first production phase is maintained at approximately 80-150% saturation.

30. The process of claim 26 wherein during the concentrate purge phase, the RO feed is split into first and second portions, the first portion being directed through the silica adsorption unit and the second portion bypassing the silica adsorption unit and combined with the effluent from the silica adsorption unit prior to being directed into the RO unit.

31. A multi-phase process for treating water containing silica in an RO system including a silica adsorption unit and an RO unit that produces a permeate and a concentrate, the process comprising:
in a first production phase:
mixing the concentrate from the RO unit with said water containing the silica to form an RO feed;
reducing the concentration of silica in the RO feed prior to reaching the RO unit by directing at least a portion of the RO feed through the silica adsorption unit located upstream from the RO unit that contains a media that adsorbs silica from the RO feed as the RO feed passes through the silica adsorption unit;
continuing the first production phase until a first setpoint is reached;
once the first setpoint is reached, switching the process from said first production phase to a second production phase;
in the second production phase: bypassing the silica adsorption unit with a substantial portion of the RO feed and directing the substantial portion of the RO feed through the RO unit to produce the permeate and the concentrate;
continuing to direct the substantial portion of the RO feed through the RO unit and causing the concentrate produced by the RO unit to become supersaturated with silica;
upon reaching a second setpoint, switching the process from the second production phase to a concentrate purge phase;
in the concentrate purge phase:
purging the supersaturated concentrate from the RO system.

32. The process of claim 31 wherein the concentrate purge phase includes purging the supersaturated concentrate from the RO system by directing the water to be treated, dilution water or permeate recycle or a combination thereof through the RO system.

33. The process of claim 31 wherein in the first production phase, the silica concentration of the concentrate is maintained at saturation.

34. The process of claim 31 wherein the silica concentration of the concentrate in the first production phase is maintained at approximately 80-150% saturation.

35. The process of claim 31 wherein during the concentrate purge phase, the RO feed is split into first and second portions, the first portion being directed through the silica adsorption unit and the second portion bypassing the silica adsorption unit and combined with the effluent from the silica adsorption unit prior to being directed into the RO unit.

36. The process of claim 31 wherein the first and second setpoints are based on the recovery rate of the RO system, the conductivity of the concentrate, timer setting or feedwater pressure.

37. The process of claim 31 wherein during the concentrate purge phase, all or substantially all of the RO feed bypasses the silica adsorption unit and is directed directly to the RO unit.

38. The process of claim 31 wherein during the concentrate purge phase, the RO feed is split into first and second portions, the first portion being directed through the silica adsorption unit and the second portion bypassing the silica adsorption unit and combined with the effluent from the silica adsorption unit prior to being directed into the RO unit.

39. The process of claim 31 wherein during the concentrate purge phase, the RO unit produces the permeate, and at least a portion of the permeate produced by the RO unit is recycled to a point upstream of the RO unit.

40. The process of claim 31 wherein the process is carried out without removing silica through chemical precipitation or other means, or without increasing the solubility of silica in the concentrate by raising the pH of the concentrate to 9.5 or greater.
